(19) United States
(12) Patent Application Publication
(10) Pub. No.: US 2006/0291700 A1
(43) Pub. Date: Dec. 28, 2006

(54) Internet signature verification system

(76) Inventor: Mark Ellery Ogram, Tucson, AZ (US)

Correspondence Address: Mark E. Ogram, 7454 E. Broadway #203, Tucson, AZ, 85710, US

(21) Appl. No.: 11/149,417

(22) Filed: Jun. 8, 2005

(51) Int. Cl. G06K 9/00; H04L 9/00

(52) U.S. Cl. 382/115; 340/5.8; 713/182; 713/176

(57) ABSTRACT

A signature authentication system which uses a digital key having a user identification stored therein. The digital key is read by a signatory computer; another computer has a document stored therein. The invention provides an authorizing computer having the capability to: receive the user identification from the signatory computer and generate a verification index based upon said user identification; receive the document from said document computer; store the user identification, the document, and the verification index within a memory; and communicate an indicia of said verification index to the signatory computer indicating that the process has been completed.

### BACKGROUND OF THE INVENTION

This invention relates generally to distributed computer systems and more particularly to authentication of users within such distributed computer systems.

Distributed computer systems, such as the Internet, have opened the door for a wide variety of commercial activities. As the Internet becomes more involved in society and is more widely accepted, the applications of the Internet's use also increase.

One area where this digital world has been encumbered is the ability to consummate contracts and other agreements. As example, when two individuals want to enter into a contract for services, while the electronic messaging and other communication capabilities found on the Internet facilitate the negotiations, the final step of “signing” the contract is often done on “hard” copies by exchanging either originals or Facsimile (FAX) contracts.

This exchange of “hard” copies takes time and often slows the process; but, within the digital world, there doesn't exist any true manner for verifying that the person who “signs” is truly that person.

An attempt is often made to establish who the individual is by using a combination of password and identification (ID) which are theoretically kept “secret” so that only the valid user is able to use them. This premise that the password/ID is not available to a fraudulent user is at best naive as hackers and identity theft operators can easily steal the password/ID and then pose as the valid user; often causing significant damage to all parties involved.

It is clear there is a need for an accurate system for “signatures” to be exchanged over a distributed system of computers such as the Internet.

### SUMMARY OF THE INVENTION

The invention is a signature authentication system. In this context, the invention relates to the creation of a system of programs which define the computer's/computers' functions and which assure that the person performing the “signature” has produced evidence of their authenticity.

Within the following discussion, the term “computer” is meant to include not only a stand-alone computer but also the use of a computer “system” or grouping or computers which work in concert to achieve the described objectives.

In this context, a computer is a device which receives, processes, and presents data to achieve a desired result. “Computer” is meant to include “programmable” apparatus well known to those of ordinary skill in the art which are adaptable to perform a specific function.

In the preferred embodiment of the invention, a digital key is created which includes a user identification stored therein. The term “digital key” in this context is a memory apparatus which is removable from a computer and which contains a medium on which is stored a unique identifier for the user.

While the preferred embodiment of the digital key uses a memory which is volatile (i.e. can be altered) such as magnetic tape, Random Access Memory (RAM), bubble memory, and other memories obvious to those of ordinary skill in the art, other embodiments of the “digital keys” utilize non-volatile memories such as Read Only Memory (ROM) and other such memories obvious to those of ordinary skill in the art.

A variety of such apparatus exist, including, but not limited to: U.S. Pat. No. 6,897,894, entitled, “Electronic Camera with Recorded Image Searching Function” issued to Miyazawa on May 24, 2005; U.S. Pat. No. 6,897,895, entitled “Digital Camera” issued to Okada on May 24, 2005; U.S. Pat. No. 6,897,506, entitled, “Systems and Methods Using Non-Volatile Memory Cells” issued to Van Brocklin et al. on May 24, 2005; and U.S. Pat. No. 6,896,618, entitled, “Point of Play Registration on a Gaming Machine” issued to Benoy et al. on May 24, 2005; all of which are incorporated hereinto by reference.

When a digital key is used, it is read by a “signatory” computer.

In this context, the term “signatory” is merely a label to differentiate this computer for reference purposes only. The same “labeling” function relates to all references herein to the computers.

When a user of the signatory computer wants to “sign” a document, the digital key is inserted by the operator into the signatory computer which reads the user identification from the memory on the digital key.

In some embodiments, another computer (sometimes referred to as the “document computer”) has a document stored therein; in other embodiments, the document is stored on the signatory computer or the authorizing computer. It is this document which is to be signed.

Another computer, designated the “authorizing” computer for reference purposes, is structured (through programming or other forms of design) to receive the user identification from the signatory computer and generate a verification index based upon said user identification. This creation of the verification index is done by comparing the user identification from the signatory computer with data within a memory accessible to the authorizing computer.

The authorizing computer also receives the document from a document computer (or as mentioned earlier, in some embodiments, from the signatory computer which serves as the document computer).

The user identification, the document, and the verification index are stored within a memory associated with the authorizing computer for later reference or retrieval. In this manner, the authorizing computer provides not only authentication of the “signature” (via the user identification on the digital key), but also a safe repository for the “signed” document which can be accessed and proven later.

The authorizing computer communicates an indicia of the verification index to the signatory computer indicating that the process has been completed. This indicia, in some embodiments of the invention, provides a reference which is used in the retrieval of the transaction from the memory associated with the authorizing computer.

In another embodiment of the invention, the authentication system, as described above, includes a representation of “evidence of identity” of the “signing” user. This “evidence of identity” is a fixed identification associated with an individual user and is used in determining if the proper party is providing the “signature”.

One such “evidence of identity” includes the user's fingerprints. Those of ordinary skill in the art readily recognize a variety of mechanisms which are capable of reading a user's fingerprint, including, but not limited to: U.S. Pat. No. 6,898,706, entitled, “License-Based Cryptographic Technique, Particularly Suited for Use in a Digital Rights Management System, for Controlling Access and Use of Bore Resistant Software Objects in a Client Computer” issued to Venkatesan et al. on May 24, 2005; and U.S. Pat. No. 6,895,502, entitled, “Method and System for Securely Displaying and Confirming Request to Perform Operation on Host Computer” issued to Fraser on May 17, 2005; both of which are incorporated hereinto by reference.

Another “evidence of identity” is the retinal portion of a user's eye. A variety of mechanisms are obvious to those of ordinary skill in the art which allow the retina of a user to be scanned and identified. These include: U.S. Pat. No. 6,896,618, entitled, “Point of Play Registration on a Gaming Machine” issued to Benoy et al. On May 24, 2005; and U.S. Pat. No. 6,892,941, entitled “Automatic Prescription Drug Dispenser” issued to Rosenblum on May 17, 2005; both of which are incorporated hereinto by reference.

Still another unique identifier is the user's facial characteristics. Mechanisms for recognizing facial characteristics are well known to those of ordinary skill in the art and include: U.S. Pat. No. 6,873,713, entitled, “Image Processing Apparatus and Method for Extracting Feature of Object” issued to Okazaki et al. on Mar. 29, 2005, incorporated hereinto by reference.

In this embodiment, the authentication of the “signing” individual is made by an authorizing computer which has data from a memory containing a pre-defined evidence of an identity of the user. Data from the signatory computer (such as the fingerprint scan, facial scan, or retina scan) is compared to the data stored with authorizing computer. This comparison, together with a comparison of the user identification from the digital key, provides an even more enhanced system of assurance that the “signing” party is who they represent themselves to be.

These two items are used for a comparison with the submitted material in creating a verification index which is stored as outlined above. As above, the verification index is communicated to the remote computer and is used, in some embodiments, when storing a document which has been “signed”.

The invention, together with various embodiments thereof, will be more fully explained by the accompanying drawings and the following descriptions thereof.

### DRAWINGS IN BRIEF

FIG. 1 graphically illustrates the preferred embodiment of the invention.

FIG. 2 is a flow chart of the preferred operation of the signatory computer.

FIG. 3 is a flow chart of the preferred operation of the authorizing computer.

FIG. 4 is a flow chart of an embodiment of the comparison operation for the authorizing computer.

FIGS. 5A, 5B, 5C, and 5D illustrate some of the various embodiments used to create a new user identification.

FIG. 6 graphically illustrates an alternative embodiment of the signatory computer.

FIGS. 7A, 7B, and 7C illustrate alternative embodiments of the auxiliary input device illustrated in FIG. 6.

FIG. 8 is a flow chart of the collection and transmittal of the user's evidence of identity.

FIG. 9 is a flow chart of the receipt and storage of the user's evidence of identity.

FIG. 10 is a flow chart of the changes made to the authorizing computer when evidence of identity is used for identification.

### DRAWINGS IN DETAIL

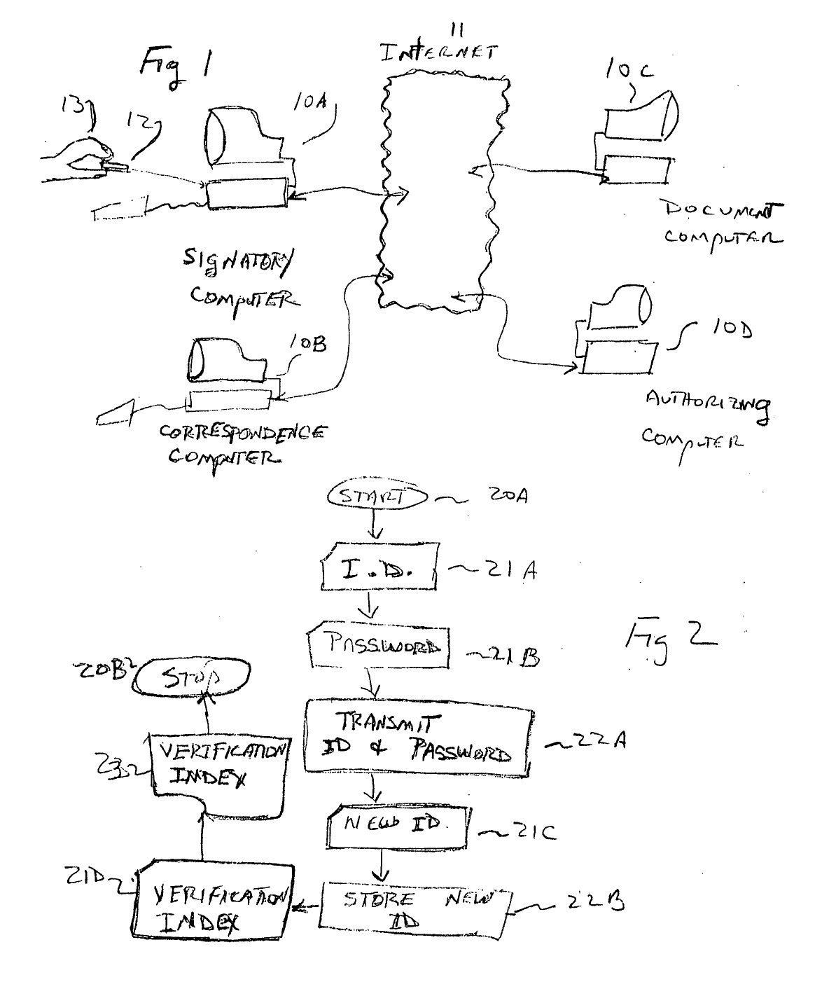

FIG. 1 graphically illustrates the preferred embodiment of the invention.

Within the discussion herein, the “computers” are individual or groupings of computers which have been configured to accomplish the tasks/functions identified. In this regard, the general purpose computers become mechanisms which have been structured or manufactured accomplish their enumerated functions. Those of ordinary skill in the art readily recognize a variety of computer languages which will configure the computers as indicated, including, but not limited to Basic, Fortran, Assembly, Cobol, and C++. The invention is not intended to be limited by the programming language used nor by the configuration of the “computer”.

In this embodiment of the invention, four computers are contemplated: The signatory computer 10A; the Correspondence Computer 10B; the document computer 10C; and, the authorizing computer 10D.

Document computer 10C, contains the document which is to be “signed” by user 13. This document is such items as: a purchase order, a contract for purchase/sale, an employment contract, a promissory note, or any of a variety of other types of documents well known to those of ordinary skill in the art. Often, this document has been “negotiated” between user 13 and a third party (such as an operator of the correspondence computer 10B) and is now in its final form, ready for signature.

In this illustration, document computer 10C is remote from the other computers; but, in other embodiments, the functionality of document computer 10C is contained within one or more of the other computers in the illustration, such as signatory computer 10A, Correspondence computer 10B, and/or authorizing computer 10D. In this regards, while the preferred embodiment of the invention uses a document computer 10C, other embodiments store the document within one of the other computers.

In this embodiment, user 13 initiates the “signing” operation through signatory computer 10A. In the preferred embodiment, user 13 inserts digital key 12 into signatory computer 12A which reads the user identification stored on digital key 12. Digital key 12 is, in the preferred embodiment, a volatile memory such as those described earlier.

Further, in the preferred embodiment, user 13 also provides a password which user 13 has previously established.

The user identification and the password is communicated via a distributed network of computers 11 (the Internet in this illustration) to the authorizing computer 10D.

The authorizing computer 10D accesses its own memory to obtain a stored identification and a stored password associated with user 13.

Authorizing computer 10D obtains the document which is to be signed. As noted earlier, the document may be obtained from a document computer 10C (as shown in this illustration); or in other embodiments, the document is obtained from the signatory computer 10A or the correspondence computer 10B. In yet another embodiment, the document is stored within the authorizing computer 10D.

Authorizing computer 10D, using the user identification and password from the signatory computer, together with the stored identification and stored password, compares the information and generates a “verification index” indicating if there is a match between: the user identification and the stored identification; and, the password and the stored password.

In this preferred embodiment of the invention, the document, the verification index, the user identification, and the password are stored into a memory, often remote from the authorizing computer. This set of stored material is used later for proof of the signature and of the document.

The authorizing computer 10D, now sends the verification index to the appropriate computers. In one embodiment of the invention, this means the verification index is sent to the signatory computer 10A, the correspondence computer 10B, and the document computer 10C; other embodiments of the invention send the verification index to selected ones of these computers as is appropriate for the situation.

In the preferred embodiment of the invention, the authorizing computer generates a new user identification. This new user identification is generated any of a number of ways obvious to those of ordinary skill in the art, including, but not limited to: randomly chosen, picked from a pre-defined data base, or configured from the date/time of the operation.

The new user identification is then stored within the memory associated with the authorizing computer 10D and is communicated to the signatory computer 10A which replaces the existing user identification on digital key 12 with the new user identification.

The signatory computer 10A replaces the user identification on the digital key 12 with the new user identification. This process provides additional security by preventing a “forger” from duplicating the digital key since the user identification on the key changes each time the digital key is used.

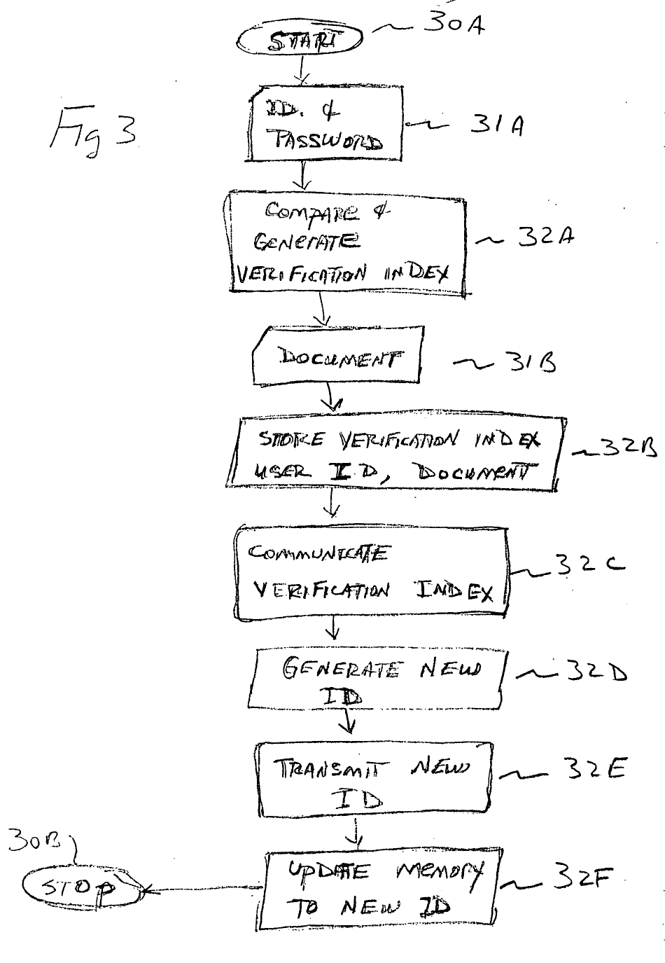

FIG. 2 is a flow chart of the preferred operation of the signatory computer.

Within the discussion herein, the flow-charts are intended to provide one of ordinary skill in the art with an understanding of the functions which each of the computers is configured to have. The order of the operations, in many situations, are given for illustration purposes only and those of ordinary skill in the art readily recognize that some of the operations are moveable without affecting the overall objective outlined in the flow chart.

Once the signatory computer starts 20A, the computer reads the user identification from the digital key 21A. Additionally, the password 21B is obtained from the user. This set of operations 20A and 21B, are illustrative of one of may situations where the order of the operations by the signatory computer is not critical to the overall objective of the signatory computer; those of ordinary skill in the art readily recognize that in some embodiments the password is obtained before the user identification.

The user identification and the password are sent to the authorizing computer 22A. A new user identification is received from the authorizing computer 21C and this new identification is written onto the digital key 22B.

The verification index 21D is received from the authorizing computer and the verification index is displayed 23 so that the user of the signatory computer knows if the “signing” of the document has been successful or not. The operation of the signatory computer then stops 20B.

FIG. 3 is a flow chart of the preferred operation of the authorizing computer.

After the operation starts 30A, the user identification and password are collected 31A from the signatory computer. A comparison is made between the collected user identification and password and an authorization index is created 32A.

The document which is being signed is collected 31B (from a memory associated with the authorizing computer or from a remote computer) and the verification index, user Identification, password, and document are placed within memory 32B for later reference.

The verification index is then communicated 32C to the appropriate computers and a new user identification is generated 32D which is transmitted 32E to the signatory computer which replaces the prior user identification with the new user identification as outlined above.

The memory is updated to reflect the new user identification 32F and the operation of the authorizing computer stops 30B.

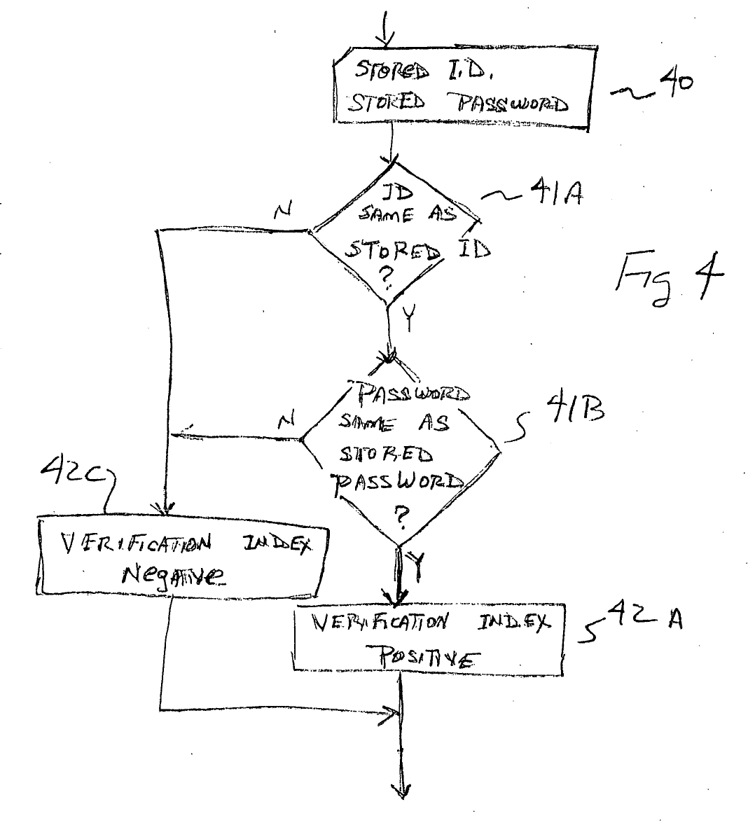

FIG. 4 is a flow chart of an embodiment of the comparison operation for the authorizing computer. In this regard, FIG. 4 illustrates the preferred technique which the authorizing computer uses to compare and generate the verification index as shown in FIG. 3, element 32A.

This embodiment withdraws the stored user identification and the stored password 40A Using the stored user identification and the user identification previously obtained, a comparison is made to see if a match occurs 41A. If there is a match, then a comparison is made between the stored password and the previously provided password 41B to see these two elements match.

Only if both comparisons (41A and 41B) are matches, is the verification index a “positive”; otherwise, the verification index is “negative” 42C.

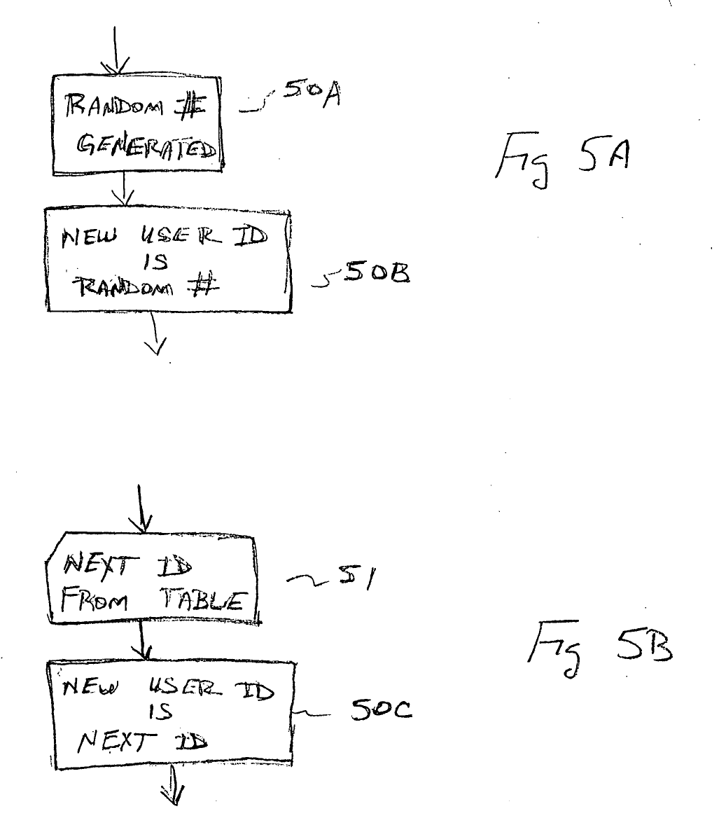

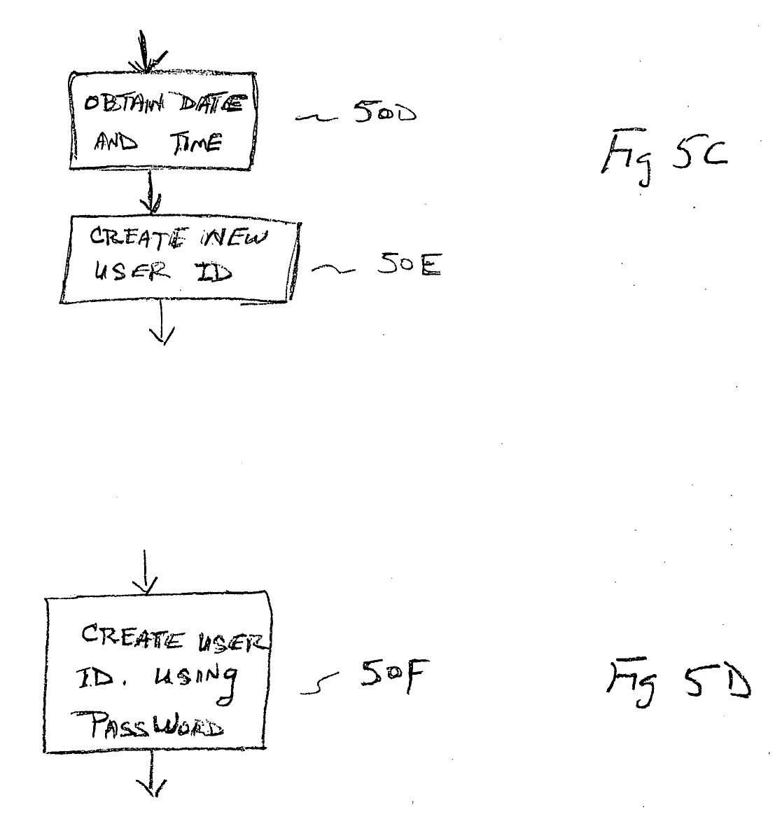

FIGS. 5A, 5B, 5C, and 5D illustrate some of the various embodiments used to create a new user identification. In this aspect, the various embodiments shown in FIGS. 5A, 5B, 5C, and 5D illustrate the operation initially shown in element 32D of FIG. 3.

Referencing FIG. 5A, in this embodiment a random number is generated 50A using any of a number of random number generators well known to those of ordinary skill in the art. This random number is then used as the new user identification 50B.

In the embodiment of FIG. 5B, a table is accessed from a memory and the next available identification is withdrawn 51.

This table is sometimes used for an individual signing user or is a general purpose table which is used for the generation of many different signing users. In this latter application (many different signing users) it is likely that the same user identification is being assigned to several different signing users. This does not cause any problems as each signing user has their own unique password as well.

The next available user identification is then used as the new user identification 50C.

The embodiment of FIG. 5C uses the date of the signing to generate a new user identification. The date and time is obtained 50D and a new user identification is created from the date and time 50E.

For purposes of illustration of one such encrypting technique for the creation of the new user identification, assume the date is designated dd/mm/yy (dd-day; mm—month; and yy—year) and the time is designated hh/mn/ss (hh—the hour, mn—minutes, ss—seconds). While those of ordinary skill in the art recognize a variety of user identification that can be generated, one such new user identification would then be:
dd/mm/yy/hh/mn/ss.

FIG. 5D illustrates the creation of the new user identification by encrypting the user password 5OF into the new user identification.

As example, assume this is the fifty-third time that the user has used the signature operation on their password of: JOHNSMITH. One such combination would create a new user identification as:

JOHNSMIT53H

FIG. 6 graphically illustrates an alternative embodiment of the signatory computer first illustrated as element 10A of FIG. 1.

This alternative embodiment for the signatory computer involves computer 63 with screen/display 60 together with keyboard 62. As before, computer 63 is able to connect to the Internet 11.

In this embodiment, an auxiliary input device 64 is provided. Auxiliary input device 64 is adapted to collect such items as retinal records, fingerprints, or facial images as noted earlier. These inputs are used for proof of the user's evidence of identity and are used in the signature verification operation.

Camera 61 is also provided to collect images which may be used for the collection of facial recognition data.

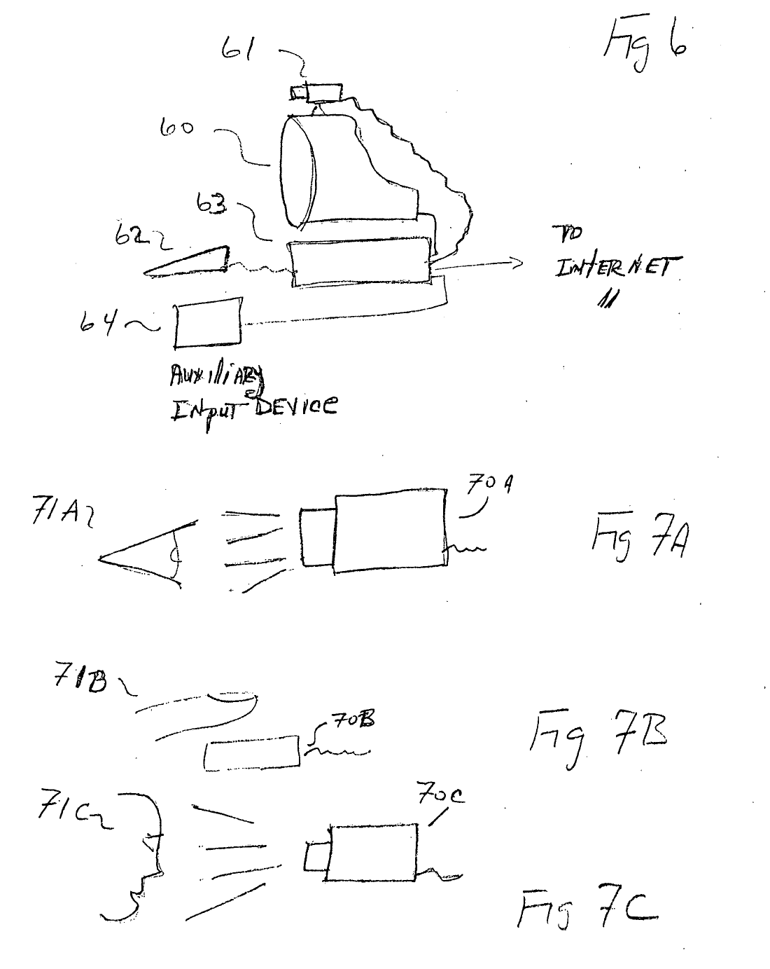

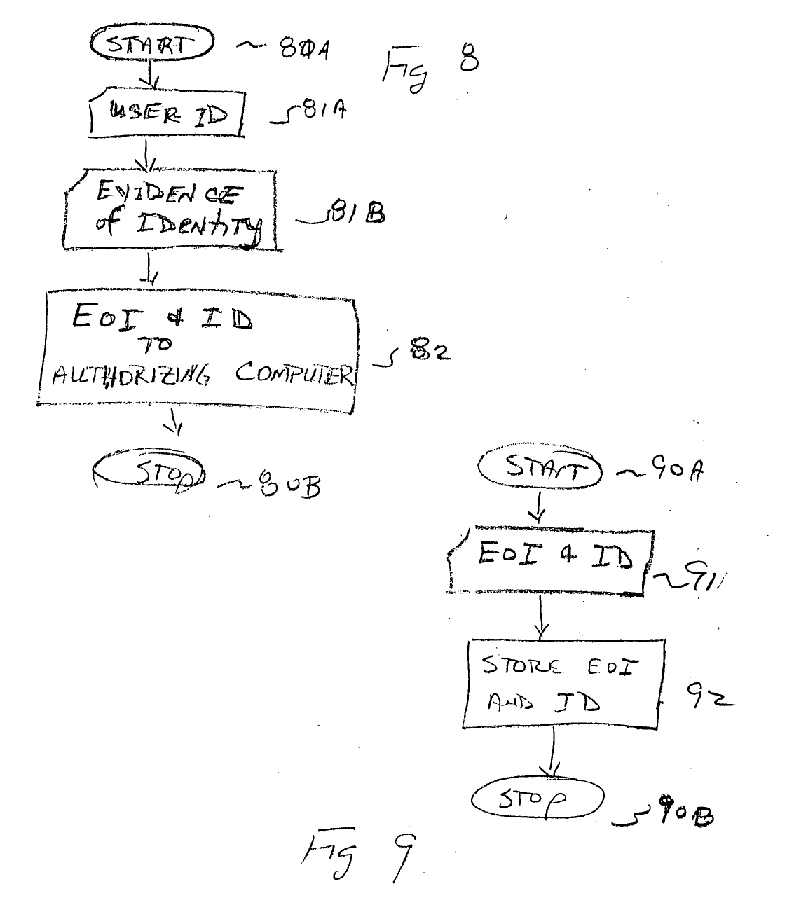

FIGS. 7A, 7B, and 7C illustrate alternative embodiments of the auxiliary input device illustrated in FIG. 6.

FIG. 7A illustrates camera 70A used as the auxiliary input device for reading the retinal configurations of the eye 71A; thereby providing the required evidence of identity for this embodiment.

In like fashion, fingerprint reader 70B is used to read the fingerprint 71B from the user to serve as the evidence of identity for an alternative embodiment.

In still another embodiment, camera 70C obtains a picture of a face 71C which serves as the evidence of identity for the signatory computer.

FIG. 8 is a flow chart of the collection and transmittal of the user's evidence of identity. This operation is typically carried out by the signatory computer or another such computer which is used to collect the evidence of identity and communicate this data to the authorizing computer. As noted earlier, the computer, once programmed or configured to carry out this task, becomes a specialized machine.

The program starts 80A and the user identification is collected 81A. This provides the basis to link the evidence of identify, which is then collected 81B. As noted earlier, the evidence of identity is one of may criteria obvious to one of ordinary skill in the art and is used to uniquely identify a user (i.e. fingerprint, retinal scan, or facial scan).

The evidence of identity (EOI) and the user identification is then communicated to the authorizing computer 82 and the program stops 80B.

Ideally, the evidence of identity is collected only once and serves as the template for later identifications.

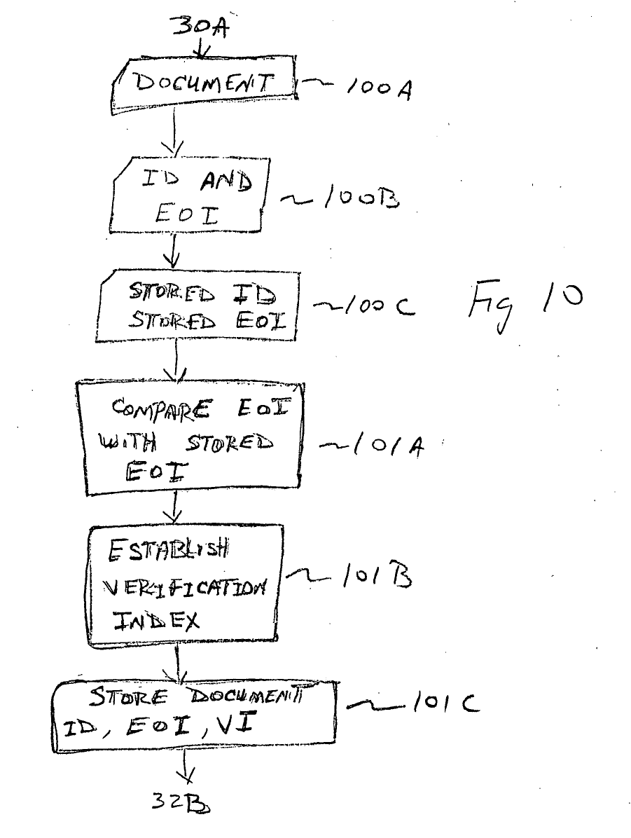

FIG. 9 is a flow chart of the receipt and storage of the user's evidence of identity. Once the evidence of identity has been collected, as outlined in FIG. 8, the authorizing computer collects and stores the information.

The operation starts 90A and the evidence of identity and user identification is collected, through the Internet in the preferred embodiment.

The evidence of identity and the user identification is stored 92 within the authorizing computer's accessible data base for later use in identifying the user/signatory party. The program then stops 90B.

FIG. 10 is a flow chart of the changes made to the authorizing computer when evidence of identity is used for identification. This particular configuration for the operation and structure for the authorizing computer relies upon the preferred embodiment illustrated in FIG. 3 and is applied in lieu of the elements 31A and 32A.

After element 30A, the document is collected 100A from its source and the user identification and evidence of identity is collected 100B from the signatory computer. The stored user identification and stored evidence of identity is collected 100C from the memory associated with the authorizing computer.

A comparison is then made between the evidence of identity collected from the signatory computer and the stored evidence of identity (which serves as a template) 101A.

This comparison permits the establishment of a verification index 101B. In many situations, this verification index will not be “positive” or “negative”, but rather a ranking or value assigned to the comparison. In the preferred embodiment, the verification index is a value between 0 and 100 (0 being no matches; 100 being a perfect match).

The authorizing computer then stores the document, the user identification, the evidence of identity, and the verification index 101C and the program continues onto step 32B found in FIG. 3.

It is clear that the present invention provides an accurate system for “signatures” to be exchanged over a distributed system of computers such as the Internet.

What is claimed is:

1. A signature authentication system comprising:
a) a digital key having a user identification stored therein;
b) a signatory computer having capability to read said user identification from said digital key;
c) a document computer having a document stored therein;
d) an authorizing computer having capability to,
1) receive said user identification from said signatory computer,
2) generate a verification index based upon said user identification,
3) receive said document from said document computer,
4) store said user identification, said document and said verification index within a memory,
5) communicate an indicia of said verification index to said signatory computer.

2. The signature verification system according to claim 1, wherein said authorizing computer further includes capability to communicate the indicia of said verification index to said document computer.

3. The signature authentication system according to claim 1, wherein said authorizing computer further includes capability to alter said user identification within said digital key to an up-dated user identification.

4. The signature authentication system according to claim 3, wherein said up-dated user identification is randomly chosen.

5. The signature authentication system according to claim 3, wherein said updated user identification is selected from a list of potential user identifications.

6. The signature authentication system according to claim 3,
a) wherein said authorizing computer includes a memory containing a pre-defined user identification; and,
b) wherein said authorizing computer includes capability to alter said pre-defined user identification with the memory of said authorizing computer to said up-dated user identification.

7. The signature authentication system according to claim 6,
a) wherein said authorizing computer further includes capability to receive a user-generated password from said signatory computer; and,
b) wherein the memory of said authorizing computer includes a pre-defined password.

8. The signature authentication system according to claim 7, wherein said verification index has a positive and a negative state.

9. The signature authentication system according to claim 8, wherein said verification index is positive only if:
a) said user identification corresponds to the pre-defined user identification; and,
b) said user-generated password corresponds to the pre-defined password.

10. The signature authentication system according to claim 1:
a) further including a correspondence computer; and
b) wherein said authorizing computer includes capability to communicate said indica of said verification index to said correspondence computer.

11. The signature authentication system according to claim 10, wherein said correspondence computer is distant from said signatory computer.

12. The signature authentication system according to claim 1, wherein said signatory computer, said document computer, and said authorizing computer communicate by a distributed network system.

13. The signature authentication system according to claim 12, wherein said distributed network system includes the Internet.

14. A signature authentication system comprising:
a) a signatory computer having capability to:
1) receive a removable digital key having a user identification stored therein, and,
2) read said user identification from said digital key; and,
b) an authorizing computer having capability to,
1) receive said user identification from said signatory computer,
2) generate a verification index based upon said user identification,
3) associate a document with said verification index, and,
4) communicate an indicia of said verification index to said signatory computer.

15. The signature authentication system according to claim 14, wherein said authorizing computer includes capability to store said user identification, said document and said verification index within a memory.

16. The signature authentication system according to claim 14, wherein said authorizing computer includes capability to alter said user identification within said digital key to an up-dated user identification.

17. The signature authentication system according to claim 16,
a) wherein said authorizing computer further includes capability to receive a user-generated password from said signatory computer; and,
b) wherein the memory of said authorizing computer includes a pre-defined password.

18. The signature authentication system according to claim 17, wherein said verification index has a positive and a negative state and wherein said verification index is positive only if:
a) said user identification corresponds to the pre-defined user identification; and,
b) said user-generated password corresponds to the pre-defined password.

19. A signature authorizing computer comprising automated capability to,
a) receive a user identification from a remote computer, said user identification originating from a digital key;
b) generate a verification index based upon said user identification;
c) associate a document with said verification index; and,
d) communicate an indicia of said verification index to said remote computer.

20. The signature authorizing computer according to claim 19, further including capability to store said user identification, said document and said verification index within a memory.

21. The signature authorizing computer according to claim 20, wherein said memory is resident within said signature authorizing computer.

22. The signature authorizing computer according to claim 20, wherein said memory is remote from said signature authorizing computer.

23. The signature authorizing computer according to claim 19, further including capability to alter said user identification within said digital key to an up-dated user identification.
